(19) United States
(12) Patent Application Publication
(10) Pub. No.: US 2010/0151300 A1
(43) Pub. Date: Jun. 17, 2010

(54) DEVICE FOR STORING ELECTRICAL ENERGY

(76) Inventors: Andreas Gutsch, Luedinghausen (DE); Holger Mikus, Kament (DE); Jörg Kaiser, Kamenz (DE); Martin Schneider, Goda (DE); Günter Eichinger, Altenstadt (DE); Tim Schäfer, Niedersachswerfen (DE)

Correspondence Address: CHOATE, HALL & STEWART LLP, TWO INTERNATIONAL PLACE, BOSTON, MA, 02110, US

(21) Appl. No.: 12/636,462

(22) Filed: Dec. 11, 2009

(30) Foreign Application Priority Data
Dec. 15, 2008 (DE) 10 2008 062 158.7

(51) Int. Cl. H01M 10/50; H01M 2/02; H01M 2/00

(52) U.S. Cl. 429/61; 429/176; 429/120

(57) ABSTRACT

The device according to the invention for storing electrical energy comprises at least one galvanic cell. The same is at least partially surrounded by a casing. Furthermore, the device comprises a cell holding unit comprising an internal space. The at least one galvanic cell is arranged in the internal space. Furthermore, the cell holding unit comprises a wall, which at least partially delimits said internal space. Therein, the wall of the cell holding unit and/or the at least one galvanic cell comprise at least one hollow space. The at least one hollow space is at least partially filled with a first heat conducting means.

The present invention relates to a device for storing electrical energy. The invention is described in regard to a rechargeable lithium-ion battery, for powering a power operated vehicle drive. Yet it is emphasized, that the invention can also be applied to batteries not containing lithium and also independently of power operated vehicles.

Batteries comprising galvanic cells for the storage of electrical energy are state of the art. For a rechargeable battery, the applied electrical energy will first be transformed into chemical energy. This energy transformation comes with a loss of energy, and also causes irreversible chemical reactions, which lead to a deterioration of the rechargeable battery. With increasing operating temperature, the energy transformation is accelerated, however, the deterioration process of a galvanic cell is also accelerated. In particular, during the acceleration process of an electrically powered power operated vehicle, large currents are withdrawn from a rechargeable battery over a short period of time. These large currents also occur in casing the de-celeration of a power operated vehicle is supported by electrical devices and the energy gained thereby is applied to the rechargeable battery.

Therein, it is of disadvantage that these short-time high currents prematurely age a battery.

The object of the present invention is to increase of lifecycle for those batteries. According to the present invention this is achieved by the subject-matter of the independent claims. Preferred embodiments and further developments are subject matter of the dependent claims.

According to the present invention, a device for the storing electrical energy comprises at least one galvanic cell. This cell is at least partially surrounded by a casing. Moreover, the device comprises at least a cell holding unit having an internal space. The at least one galvanic cell is arranged in the internal space. Moreover, the cell holding unit comprises a wall, which at least partially limits the internal space. Therein, the wall of the cell holding unit and/or the at least one galvanic cell comprises at least one hollow space. This at least one hollow space is at least partially filled with a first heat conducting means.

The device for storing electrical energy comprising at least one galvanic cell is either a primary or a secondary battery. This battery provides electrical energy after transforming chemical energy. In case the device is a secondary battery, the device is capable of receiving electrical energy, and of transforming it into and storing it as chemical energy. The device comprises, in addition to the least one galvanic cell, further devices for a controlled operation and powers the engine of a power operated vehicle.

According to the present invention the device comprises at least one galvanic cell. Preferably, the device comprises several galvanic cells which are arranged in parallel and/or in series. Thereby, the electrical voltage and/or the charge as stored will be increased. Preferably, several galvanic cells are arranged in serial connection as to reach a predefined level of operational voltage. Several of these groups are then preferably arranged in parallel as to store a higher amount of electrical charge.

A galvanic cell is at least partially surrounded by a casing. The casing protects the galvanic cell and the chemicals contained therein, from external damaging actions, for example, from ambient water vapour. The casing is preferably formed by a gas-proof and electrically isolating solid or laminar composite, for example, a foil. Preferably, the casing is thin-walled and heat conductive. The casing preferably encloses the galvanic cell, further preferably and without gaps and air cushions to the extend possible. This allows for proper heat conducting from the inner galvanic cell through the casing.

The device comprises at least one cell holding unit. This cell holding unit preferably, holds further devices other than the galvanic cells, for example, measuring devices, control units as well as other devices or parts that are necessary for the proper operational use of the accumulator. The casing also allows the connection and mounting to the power operated vehicle. The casing encloses the galvanic cells as accommodated, preferably in a tight fit and without air cushions. This way, the casing of the galvanic cells, respectively, the galvanic cells with the casing, are capable of exchanging a large amount of heat. A heat flow can be exchanged in both directions.

The casing and/or the at least one galvanic cell, comprises also at least one hollow space. The at least one hollow space is at least partially surrounded by the casing of the at least one galvanic cell. The hollow space is limited by a cover, which is provided to exchange heat with the casing and/or the at least one galvanic cell. In case the device comprises several galvanic cells, each of these cells preferably contains it own hollow space. Preferably, several of the hollow spaces are connected to each other and are also connected to a hollow space of the casing.

This at least on hollow space is at least partially filled with a first heat conducting means. This first heat conducting means serves to support the exchange of heat between the casing and/or the at least one galvanic cell. Preferably, this first heat conducting means shows a higher thermal conductivity than a material of the casing and/or the galvanic cell. For the first heat conducting means, single or composite materials may be considered, in particular, an alloy or a suspension.

According to the present invention, by using at least one hollow space for a device for storing electrical energy, it is possible to affect the heat balance of the device or of galvanic cells contained therein. A device for the storage of electrical energy, which contains at least one galvanic cell, is preferably operated within a certain temperature range. Below a certain minimum temperature, the transformation of chemical into electrical energy is slowed down. Therein, the electrical performance of such a device is limited and certain demand in electrical energy may not be deliverable. Depending on the use of the device, for example in an power operated vehicle in a cold environment, it may be helpful to warm up the device or the galvanic cell, respectively. The present invention contributes to this end by improving the heat supply into the device or into the galvanic cells thereof.

Above a certain temperature, the lifecycle of the device or of their galvanic cells can be noticeably reduced. Also, above a certain temperature the deterioration of a galvanic cell is accelerated due to irreversible chemical reactions. According to the present invention, the specific realization of a device for the storage of electrical energy can at least minimize those damages. Heat energy can more easily be conducted from the device or from the galvanic cells. Irreversible chemical reactions, which lead to an aging of the device, are reduced. Thereby, the initially outlined problem is solved.

In the following, preferred embodiments and further developments are described.

A2 Advantageously, a second heat conducting means is provided between the casing of the cell holding unit and the at least one galvanic cell. This means can also be arranged only in areas thereof, in particular in areas where a high heat load is to be transmitted. Therein, the second heat conducting means is in close material contact with parts of the casing of a galvanic cell as well as with parts of the wall of the cell. For example, the second heat conducting means can be a heat conducting paste. This paste is then applied as a thin layer between casing and wall. The second heat conducting means can also be a foil or a tailor-made mat. For example, the second heat conducting means acts to expand the area available for heat transfer. The second heat conducting means can also be arranged between two adjacent galvanic cells. The arrangement of the second heat conducting means helps to avoid that, for example, isolated air cushions inhibit heat transfer.

A3 Advantageously, the first heat conducting means is capable of undergoing phase changes under certain conditions. During said phase change, the temperature of the first heat conducting means remains essentially unchanged. Thereby, the first heat conducting means can act stabilizing in regard to the temperatures of adjacent components. The first heat conducting means can be selected in a way, so that the temperature of the phase change essentially corresponds to the desired operating temperature of the device or of the galvanic cells, respectively. Preferably, the first heat conducting means is selected in a way, so that a temperature of a phase change is adjusted to the maximum tolerable operating temperature of the device or of the galvanic cells, respectively. It is particularly preferred, that the temperature of a phase change is equal the maximum operating temperature, or slightly less.

A4 Advantageously, the first heat conducting means is at least partially capable of flowing. Preferably, the first heat conducting means is at least partially liquid at the desired operating temperature of the device. The first heat conducting means can also be an suspension, wherein its solid components have the ability of phase change n the range of operating temperature of the device.

Equally advantageously, the at least one hollow space of the device is configured to guide the first heat conducting means. For this purpose, the hollow space can be shaped in a tubular manner having any conceivable cross-section. The dimensions of a cross sectional area of a hollow space are adjusted to the dimensions of a galvanic cell and/or a casing of the cell holding unit. For example, the hollow space is designed as a closed tube, which also may protrude from the device. Outside of the device, heat energy can be supplied to or dissipate from the hollow space. Within the tube, natural (thermal) convection can lead to the transfer of the first heat conducting means.

A5 The at least one hollow space is advantageously connected with a container. This container can function as a storage container or as an expansion tank. Those containers are designed for the up-take of at least part of the first heat conducting means. Thereby, the degree to which the hollow space is filled with the first heat conducting means can be changed and adjusted to the operational conditions of the battery. Preferably, an additional first component is added into the at least one hollow space in order to reduce a temperature increase within the device and/or within the galvanic cells, respectively. Thereby, the ability of the first heat conducting means to take up or to release heat energy due to phase change will be adjusted to the respective operating condition of the device.

A6 Advantageously, a delivery device for the transport of the first heat conducting means is provided. The delivery device transports the first heat conducting means through the first hollow space and/or exchanges parts of the first heat conducting means to the container/vessel and the at least one internal space, and vice versa. Preferably, said transport occurs on demand. Based on this embodiment, the operating temperature of the device can be stabilized over a long period of time, for example, during a period of acceleration of a power operated vehicle.

A7 Advantageously, a heat exchanger is assigned to the device. The heat exchanger is preferably connected to the at least one hollow space. Therein, the first heat conducting means flows through the heat exchanger and/or the heat exchanger exchanges heat energy with said first heat conducting means. The heat exchanger withdraws the required heat energy required for heating the first heat conducting means, for example, from the ambient air, or from an air stream. The heat exchanger also can deliver heat energy to any conceivable heat sink. Preferably, said heat exchanger is heated electrically.

A8 Advantageously, a control unit, a operational unit, and at least one first measuring unit is assigned to the device. The control unit controls at least the existing measuring units and analyzes the signals thereof. This is based on predefined algorithms. The algorithms take into account the different characteristics of individual measurement means of the first measuring unit.

At least a first measuring unit is provided for temperature analysis of a predefined area of a galvanic cell. Preferably, several measuring devices for recording the temperature of various areas of one or several galvanic cells are connected with a first measuring unit. A measuring unit is suited to receive signals from the measurement means at any time. For practical reason, and to reduce the amount of data, data acquisition is preferably performed only from time to time. Preferably, data recorded by the first measuring unit are filtered or condensed. A first measuring unit provides recorded data to the control unit at least from time to time. Preferably, the control unit triggers the data capturing via a first measuring unit and depending on the operating conditions of the device or of the galvanic cells, respectively. Preferably, the control unit compares a recorded value of a first measuring unit with a predefined target value.

The target value can be saved in a storage unit that is associated with the control unit. In the present case, a target value is understood to be a predetermined value or a predetermined course of a functional parameter.

Dependent on the result of this comparison, the control unit operates an operational unit. In the present case, an operational unit also includes a device for the transport of a fluid, an electrical switch valve, an electrical switch, an electronic switch, or a proportional control. The different forms of the operational units have in common, that they can influence the volume of the stream of the first heat conducting means and/or that they can influence the supply/influx or outflux of the heat energy from the battery and from the galvanic cells, respectively. If necessary, the control unit controls additional units of the device.

A9 Advantageously, the device is provided with a second measuring unit. The second measuring unit preferably is suitable to record the pressure, for example, within the at least one hollow space. The second measuring unit can also record a pressure difference, for example, before and after an aperture, which is arranged within a stream of the first heat conducting means. The signals of a second measuring unit are also provided to the control unit and, if applicable, analyzed. By recording a pressure or a pressure differences, respectively, it is possible to gain insight into the performance of the first heat conducting means. For example, the progressing phase change of the first heat conducting means can be determined.

A10 Advantageously, the control unit of the device is connected, via signals, with a higher-level control of a signal of a power operated vehicle, for example, through certain connections. From time to time, the control unit provides information to the higher-level control (system), said information regarding operating conditions of the device, information on the progress of the software of the control unit and/or particularly, the occurrence of unplanned incidents and conditions, respectively. Particularly, any overstepping of the maximum acceptable operating temperature of the device will be transmitted to the higher-level control of the power operated vehicle.

A11 Advantageously, the device according to the present invention is operated in a manner, so that a first measuring unit will capture, as predetermined or upon request from the control unit, a measuring value of at least one galvanic cell or of the batteries, respectively. This measuring value is compared with a predefined target value by the control unit.

In the present case, a target value indicates a predetermined value or a predetermined course of a functional parameter. In accordance with the present invention, a functional parameter is to be understood to be a value or a temporal development of a physical quantity, which is suited to provide information on the operating conditions of a galvanic cell or on the device, respectively. For example, such a parameter can be the storage capability of a galvanic cell, the electrical voltage measured between the two poles of a galvanic cell, the amplitude of an electrical current that leads to charge or discharge, the internal resistance of a galvanic cell, the already charged or available electrical charge of the galvanic cell, possible leakage currents within the galvanic cell, or the temperature of the galvanic cell. Depending on the requirements of the operational use of the device, other physical quantities can also be of significance.

As soon as a measuring value deviates significantly from a predefined target value, the control unit will operate an operational unit and/or on the delivery/transportation device.

A12 The deviation and/or the operation of the operating unit can also be transmitted to the higher-level control. For this process, predefined signals, the meaning of which is understood by the higher level control are used.

Additional benefits, characteristics and possible applications of the present invention can be found in the subsequent description in context with the figures. It shows:

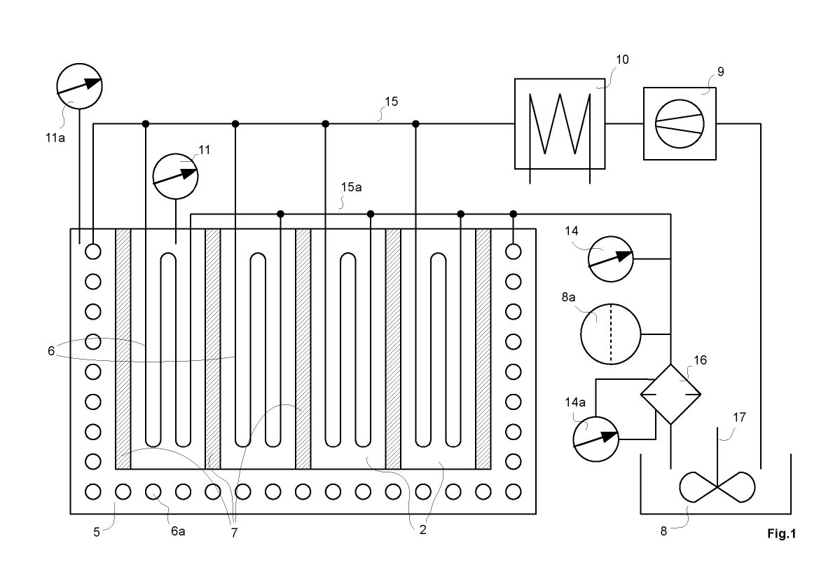

FIG. 1. Cross-section of a device according to the present invention,

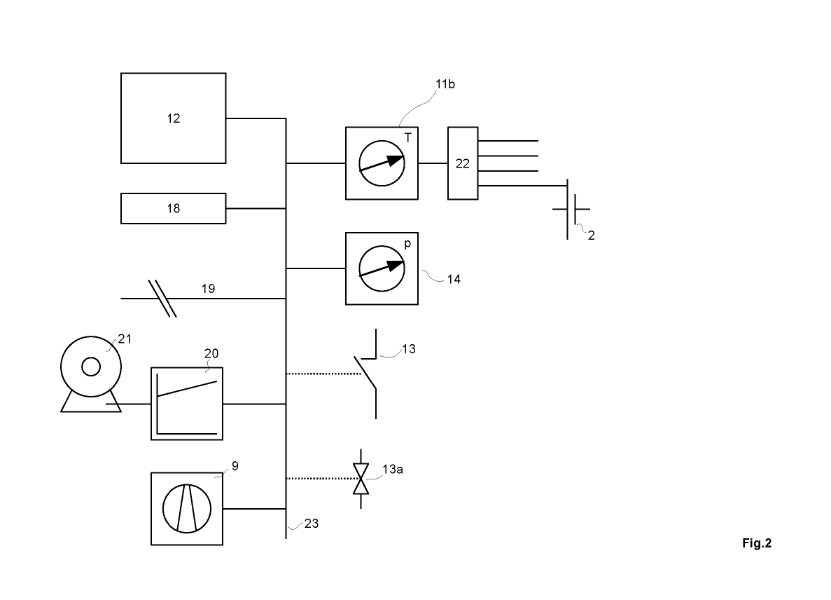

FIG. 2. An arrangement of control and measuring units according to the present invention.

FIG. 1 shows a device for storing electrical energy according to the present invention, in a preferred embodiment. The battery as shown is provided with four galvanic cells (2). Between the galvanic cells (2), and also between one galvanic cell (2) and the casing (5), of the cell holding unit, second heat conducting means (7) are arranged. The second heat conducting means (7) comprises a heat conducting paste, which is applied in a thin layer. The galvanic cells (2) as well as the casing (5) contain a hollow space (6, 6a), which is partially filled with the first heat conducting means. The internal spaces are connected with each other and form a tubing. The tubing is provided as a supply pipe (15) and a return pipe (15a). The tubing is filled with a first heat conducting means that is capable of flowing. The circulation of the first heat conducting medium starts at the storage container (8). Pump (9) uptakes the first heat conducting means from the storage container (8) and delivers the same along the supply pipe (15) through the heat exchanger (10). From the supply pipe (15), the volume flow of the first heat conducting means is distributed to the galvanic cells (2) and the casing (5), respectively. After the volume flow of the first heat conducting means leaves the galvanic cells (2) and the casing (5), respectively, it will be united in the return pipe (15a). The first heat conducting means reaches the pressure transducer (14), the expansion tank (8a), as well as the throttle aperture (16) before it reaches the storage container (8).

Under operating conditions of the device, the first heat conducting means is preferably present as a suspension of a liquid of low viscosity and a a solid material dispersed therein. The solid material is selected in a way, so that it passes a phase change during the maximum allowable operating temperature of the battery and of the galvanic cells thereof. The storage container (8) is provided with a stirring device (17) to help maintaining the suspension.

The first measuring units (11, 11a) are used to record the temperature of the galvanic cells (2) and of the casing (5). As an example, only a single galvanic cell (2) is shown, comprising a thermo element (11). The second measuring units (14, 14a) are used to record the absolute pressure of the supply pipe (15), as well as the loss of pressure of the throttle aperture (16). The expansion tank (8a) is used to compensate the volume increase, that occurs when the liquid phase of the process fluid partially evaporates. It is not necessary, that the device comprises an expansion tank (8a).

FIG. 2 schematically outlines several devices, which are involved in regulating the temperature of the battery as well as their electrical (inter)connections. The following are connected to the signal bus: a control unit (12), a storage unit (18), a first measuring unit (11b) to record the temperature, a second measuring unit (14) to record the pressure or the differential pressure, respectively, two operating units (13, 13a) as well as a delivery pump (9). In this example, the signal bus (23) is provided with an additional signal line (19), to connect with a higher-level control, as well as a controller (20), to control the drive of the power operated vehicle. The first measuring unit (11b) is connected with a operational unit (22). Several thermoelements are connected with said unit, which also capture the temperature from at least one galvanic cell (2).

The device is operated in a manner, so that the first measuring unit (11b) regularly captures the temperatures of the available galvanic cells (2), as well as of the casing. The control unit (12) compares the measured temperature with predefined target values, which are stored in the storage unit (18). Depending on the calculated deviations, the control unit (12) triggers an operational unit (13), an electrical valve (13a), or the delivery pump (9) for the delivery of the first heat conducting means. If necessary, signal line (19) can transmit a signal to the higher-level operation unit.

1. A device for storing of electrical energy comprising at least one galvanic cell, which is at least partially surrounded by a casing; and
a cell holding unit having an internal space and a casing, which at least partially delimits the internal space,
wherein the at least one galvanic cell is arranged inside the internal space, and wherein at least one of the casing and the at least one galvanic cell include at least one hollow space
wherein the at least one hollow space is at least partially filled with one first heat conducting means.

2. Device The device according to claim 1, further comprising at least one second heat conducting means is at least partly arranged between the casing and the galvanic cell.

3. Device The device according to claim 1, wherein the first heat conducting means is capable of at least partially undergoing a phase change and that the phase change occurs at predetermined conditions, which are adapted to the operating conditions of the at least one galvanic cell.

4. The device according to claim 1, wherein the first heat conducting means is at least partially capable of flowing and that the at least one hollow space is configured to guide the first heat conducting means.

5. The device according to claim 4, wherein the device is associated with at least one container, which is connected with the at least one hollow space.

6. The device according to claim 1, wherein the device is assigned to a delivery unit, which is provided to deliver the first heat conducting means.

7. The device according to claim 1, further comprising a heat exchanger, which is provided to exchange heat energy between the first heat conducting means and a heat sink.

8. The device according to claim 1, wherein the device is assigned to at least a first measuring unit, a control unit and an operating unit, wherein the control unit is provided to operate the operating unit.

9. The device according to claim 8, wherein the device is assigned to a second measuring unit, which preferably records a pressure or pressure differences.

10. The device according to claim 1, wherein the control unit is capable of exchanging signals with a higher level control.

11. The device according to claim 8, further comprising a measuring unit measuring value, wherein the control unit, depending on a deviation of the measuring value from a predefined target value, operates at least one of an operating unit and a delivery unit.

12. The device according to claim 11, wherein the control unit, depending on a deviation of the measuring value from a predefined target value, sends a predefined signal to a higher level control.
